(19) United States
(12) Patent Application Publication
(10) Pub. No.: US 2013/0048446 A1
(43) Pub. Date: Feb. 28, 2013

(54) ADJUSTMENT DEVICE FOR HYDRAULIC BRAKE SYSTEMS

(71) Applicant: Wayne-Ian Moore, Changhua City (TW)

(72) Inventor: Wayne-Ian Moore, Changhua City (TW)

(21) Appl. No.: 13/218,463

(22) Filed: Aug. 26, 2011

(51) Int. Cl. B60T 11/10; F16D 65/32; B60T 7/08

(52) U.S. Cl. 188/152

(57) ABSTRACT

An adjustment device for hydraulic brake systems includes a hollow case and a retractable unit. The hollow case has a rotatable ring to control the retractable unit. One end of the hollow case is connected to a hydraulic hose, and another end is connected to a brake lever. When the user adjusts the rotatable ring, the retractable unit exerts one adjustable pressure on the hydraulic oil constantly so that the user can easily press the brake lever to slow down the vehicles.

### FIELD OF THE INVENTION

The present invention relates to an adjustment device, and more particularly to an adjustment device for hydraulic brake systems.

### BACKGROUND OF THE INVENTION

In order to make the brake system to work efficiently, most of the conventional brake systems are operated by the hydraulic force. The hydraulic brake system comprises a hydraulic hose, a brake lever unit and a brake disk system. One end of the hydraulic hose is connected to the brake lever unit and another end is connected to the brake disk system. Thus, when a user presses the brake lever, a piston is moved by the brake lever. The moving piston exerts a pressure on the hydraulic oil in the hydraulic hose so that the pressure activates the brake disk system for slowing down the vehicles. However, the whole brake system (said the brake lever unit, the hydraulic hose and the brake disk system) is an isolated system and the hydraulic oil is only flowing within this isolated system. Therefore, when the user presses the brake lever unit, the hydraulic oil generates a hydraulic pressure to drive the brake disk system for slowing down a vehicle. The magnitude of this hydraulic pressure is completely dominated by how much force the user presses the brake lever unit. Therefore, if this hydraulic pressure would be further adjusted, the user would easily brake the vehicle and the performance of the brake system would be more efficient.

The present invention has arisen to mitigate and/or obviate the disadvantages of the conventional art.

### SUMMARY OF THE INVENTION

The main objective of the present invention is to provide an improved adjustment device for hydraulic brake systems.

To achieve the objective, an adjustment device for hydraulic brake systems comprises a hollow case having a first part, a second part and a connection member, the connection member connected between the first and the second parts, the first part having a first connection end for connecting to a hydraulic hose, the second part having a second connection end for connecting to a brake lever, the connection member having a rotatable ring, a retractable unit set into the hollow case and adjusted by the rotatable ring, the retractable unit having an inner tube and an outer tube, the inner tube having one end connected to an inside of the second part and located close to the second connection end, the inner tube being a hollow tube and communicating with the first and second connection ends, the outer tube having a piston, the piston located close to the first connection end and engaged with the first part, the outer tube having an adjustment thread defined in an outside thereof and the adjustment thread corresponding to the rotatable ring, the rotatable ring having a driving thread engaged with the adjustment thread, one pair of the rubber rings located at the inner tube and surrounded by the outer tube, another pair of the rubber rings located at the piston and surrounded by the first part, thereby the hydraulic oil is difficult to leak into either outer tube or inner tube, the rotatable ring having a skidproof structure such that the user can easily rotate the rotatable ring.

The first connection end is connected to the hydraulic hose and the second connection end is connected to the brake lever such that the adjustment device for hydraulic brake systems is set up. When the rotatable ring is rotated, the outer tube is moved to push or to pull the piston within the inner space of the hollow case for adjusting the size of the inner space in the hollow case. Therefore, the piston has exerted one adjustable pressure on the hydraulic oil constantly so that a user can easily press the brake lever to slow down the vehicles.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view of an adjustment device for hydraulic brake systems in accordance with the present invention;

FIG. 2 is a perspective view of the adjustment device for hydraulic brake systems in accordance with the present invention;

FIG. 3 is an exploded view for showing a relation among the adjustment device for hydraulic brake systems, the brake lever and the hydraulic hose;

FIG. 4 is a cross-sectional view of the adjustment device for hydraulic brake systems along line 44 in FIG. 2 for showing a rotatable ring in the initial status;

FIG. 5 is a cross-sectional view of the adjustment device for hydraulic brake systems along line 44 in FIG. 2 for showing the rotatable ring in the operating status.

### DETAILED DESCRIPTION OF THE PREFERRED EMBODIMENT

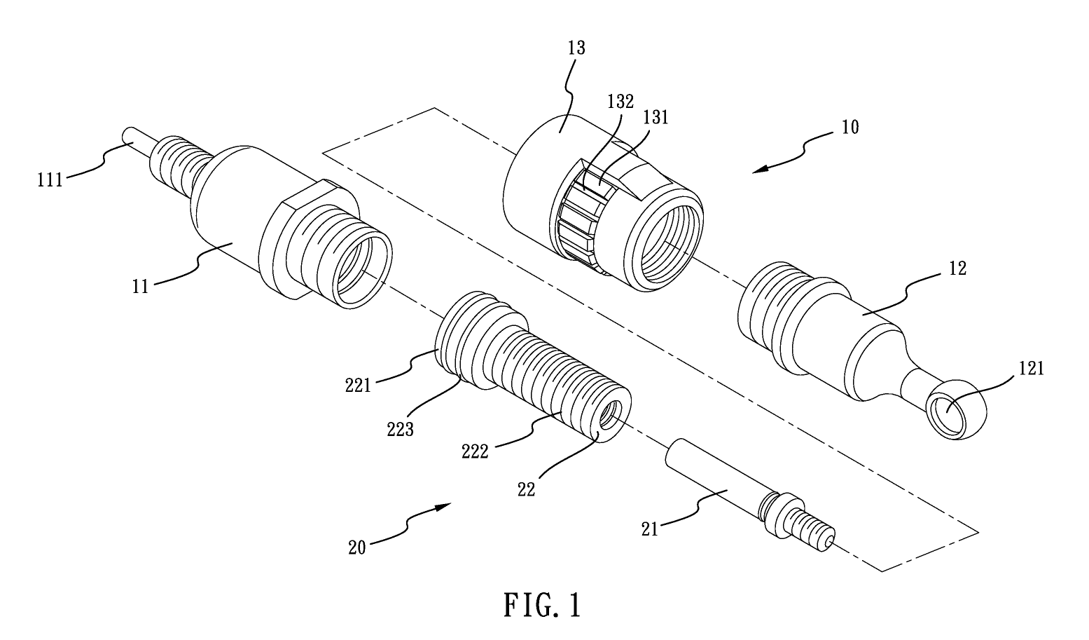

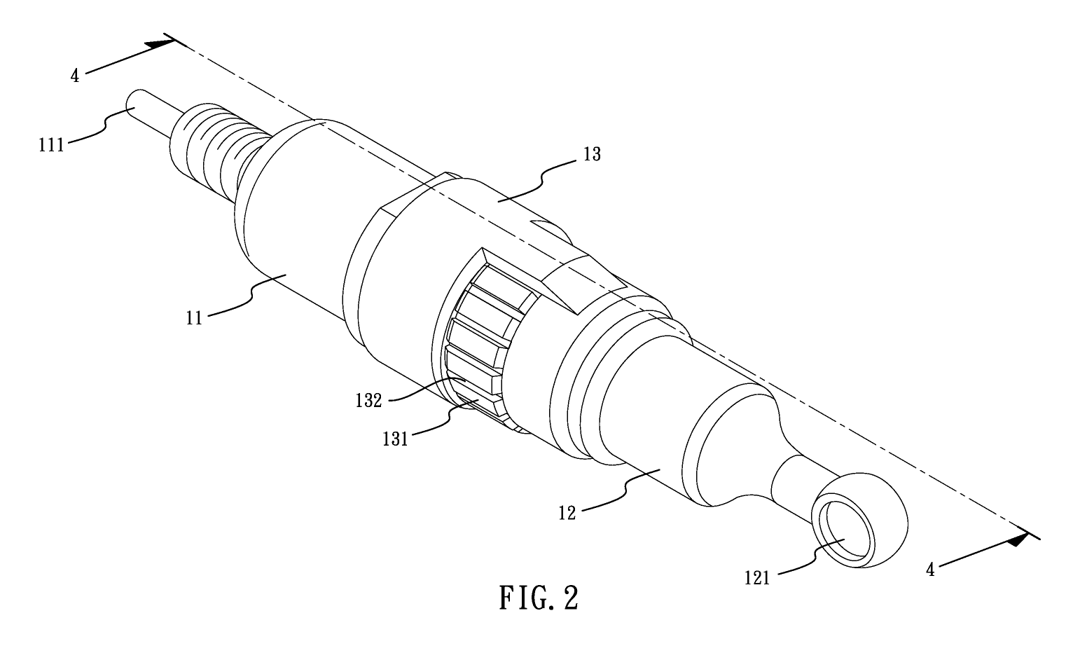

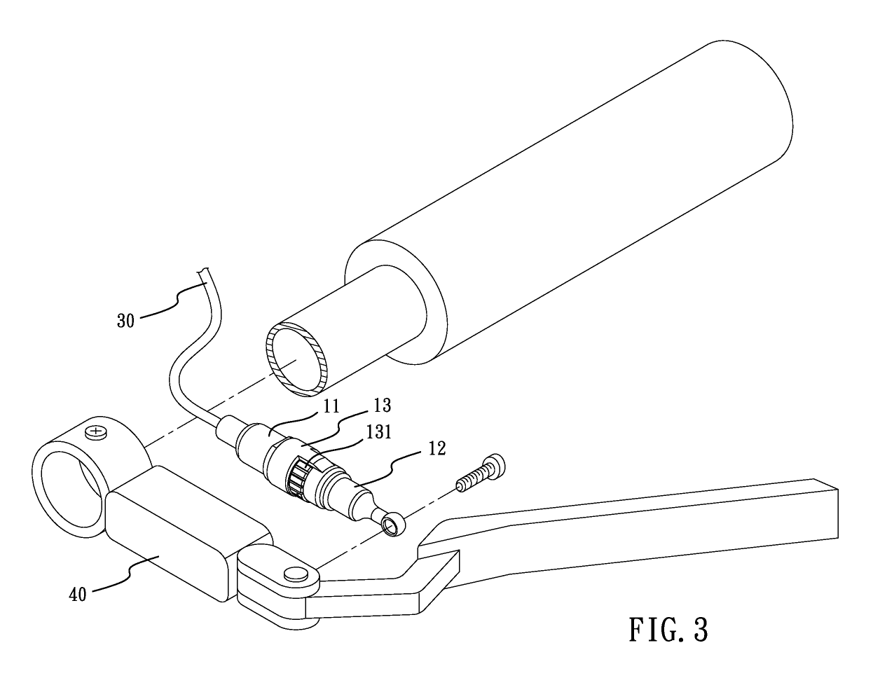

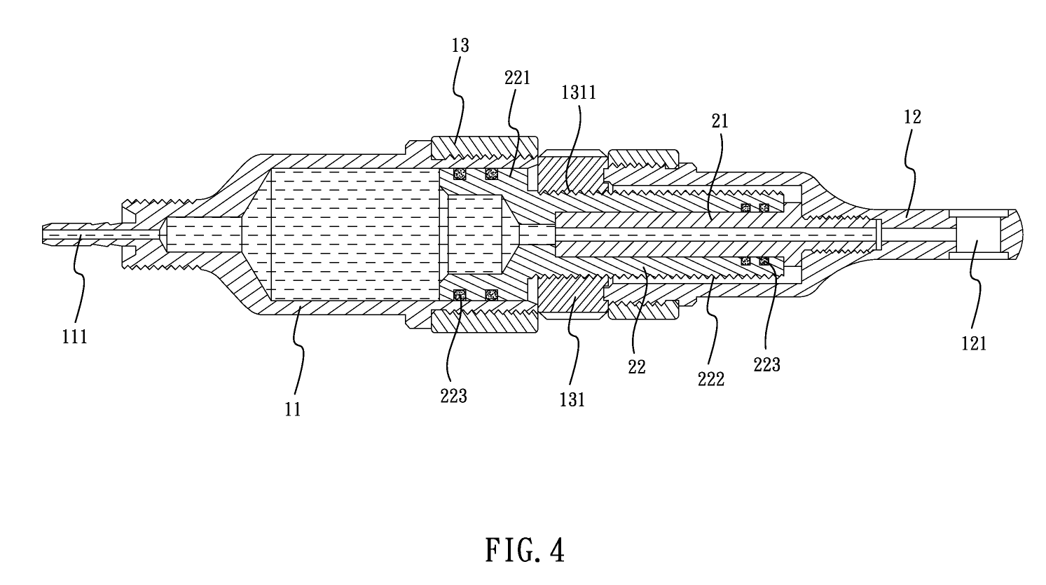

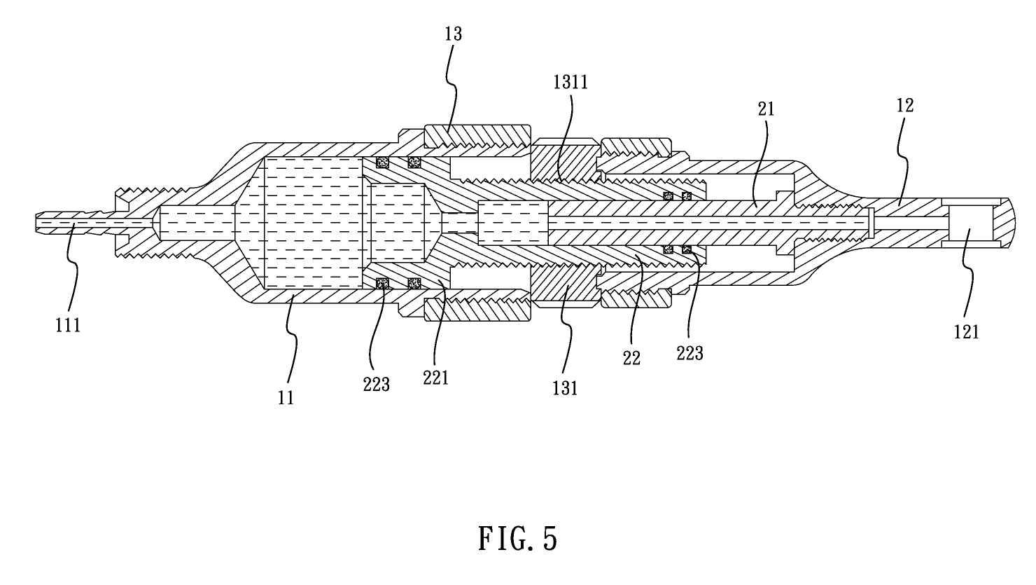

Referring to FIGS. 1 to 5, an adjustment device for hydraulic brake systems of the present invention comprises a hollow case 10 and a retractable unit 20 which is set into the hollow case 10.

The hollow case 10 comprises a first part 11, a second part 12 and a connection member 13. The connection member 13 is connected between the first and second parts 11, 12. The first part 11 has a first connection end 111 for connecting to a hydraulic hose 30. The second part 12 has a second connection end 121 for connecting to a brake lever 40. The connection member 13 has a rotatable ring 131 for adjusting the retractable unit 20.

The retractable unit 20 set into the hollow case 10 comprises an inner tube 21 and an outer tube 22. The inner tube 21 has one end connected to the inside of the second part 12 and located close to the second connection end 121. The inner tube 21 is a hollow tube which communicates with the first and second connection ends 111, 121. The outer tube 22 has a piston 221 which is located close to the first connection end 111 and engaged with the first part 11. The outer tube 22 has an adjustment thread 222 defined in the outside thereof and the adjustment thread 222 is corresponding to the rotatable ring 131. The rotatable ring 131 has a driving thread 1311 engaged with the adjustment threads 222.

The first connection end 111 is connected to the hydraulic hose 30 and the second connection end 121 is connected to the brake lever 40, thereby the adjustment device for hydraulic brake systems is set up. When the rotatable ring 131 is rotated, the outer tube 22 is moved to push or to pull the piston 221 within the inner space of the hollow case 10 for adjusting the size of the inner space in the hollow case 10. In other words, the piston 221 has exerted one adjustable pressure on the hydraulic oil constantly so that a user can easily press the brake lever to slow down the vehicles. The adjustment device for hydraulic brake systems further has two pair of rubber rings 223. One pair of the rubber rings 223 is located at the inner tube 21 and surrounded by the outer tube 23. Another pair of the rubber rings 223 is located at the piston 221 and surrounded by the first part 11. Therefore, the hydraulic oil is difficult to leak into either outer tube 22 or inner tube 21. In addition, the rotatable ring 131 has a skidproof structure 132 so that the user can easily rotate the rotatable ring 131.

Although the invention has been explained in relation to its preferred embodiment, it is to be understood that many other possible modifications and variations can be made without departing from the spirit and scope of the invention as hereinafter claimed.

What is claimed is:

1. An adjustment device for hydraulic brake systems comprising:
a hollow case having a first part, a second part and a connection member, the connection member connected between the first and the second parts, the first part having a first connection end for connecting to a hydraulic hose, the second part having a second connection end for connecting to a brake lever, the connection member having a rotatable ring; and
a retractable unit set into the hollow case and adjusted by the rotatable ring, the retractable unit having an inner tube and an outer tube, the inner tube having one end connected to an inside of the second part and located close to the second connection end, the inner tube being a hollow tube and communicating with the first and second connection ends, the outer tube having a piston, the piston located close to the first connection end and engaged with the first part, the outer tube having an adjustment thread defined in an outside thereof and the adjustment thread corresponding to the rotatable ring, the rotatable ring having a driving thread engaged with the adjustment thread;
wherein the first connection end is connected to the hydraulic hose and the second connection end is connected to the brake lever such that the adjustment device for hydraulic brake systems is set up; when the rotatable ring is rotated, the outer tube is moved to push or to pull the piston within the inner space of the hollow case for adjusting the size of the inner space in the hollow case, thereby the piston has exerted one adjustable pressure on the hydraulic oil constantly so that a user can easily press the brake lever to slow down the vehicles.

2. The adjustment device for hydraulic brake systems as claimed in claim 1, wherein one pair of the rubber rings is located at the inner tube and surrounded by the outer tube; another pair of the rubber rings is located at the piston and surrounded by the first part; thereby the hydraulic oil is difficult to leak into either outer tube or inner tube.

3. The adjustment device for hydraulic brake systems as claimed in claim 1, wherein the rotatable ring has a skidproof structure such that the user can easily rotate the rotatable ring.
